(19) United States
(12) Patent Application Publication
(10) Pub. No.: US 2025/0373580 A1
(43) Pub. Date: Dec. 4, 2025

(54) ASYNCHRONOUS COMMUNICATION ACROSS NODES IN A MESH NETWORK

(71) Applicant: Silicon Laboratories Inc., Austin, TX (US)

(72) Inventor: Mustafa Shamsi, Hyderabad (IN)

(21) Appl. No.: 18/678,093

(22) Filed: May 30, 2024

(51) Int. Cl. H04L 51/58; H04L 51/42; H04W 52/02; H04W 84/18

(52) U.S. Cl. CPC H04L 51/58; H04L 51/42; H04W 52/0229; H04W 84/18

(57) ABSTRACT

In one example, a method includes: receiving, in a second wireless device of a mesh network, a first message directed to a first wireless device of the mesh network, where the second wireless device is designated as a mailbox device for the first wireless device; determining whether the first wireless device is available; and in response to determining that the first wireless device is not available, storing the first message in a first queue of the second wireless device, the first queue associated with the first wireless device.

### BACKGROUND

With the increasing penetration of Internet of Things (IoT) devices, IoT network density is poised to increase in the near future. With the increasing number of IoT devices, economic and ecological concerns over battery-powered devices continue to increase.

One of the major challenges of low power IoT devices is intermittent computing. When a device is intermittently powered and/or connected, communications with the device become difficult as the device may not be available when a given communication is directed to the device.

### SUMMARY OF THE INVENTION

In one aspect, a method includes: receiving, in a second wireless device of a mesh network, a first message directed to a first wireless device of the mesh network, where the second wireless device is designated as a mailbox device for the first wireless device; determining whether the first wireless device is available; and in response to determining that the first wireless device is not available, storing the first message in a first queue of the second wireless device, the first queue associated with the first wireless device.

In one implementation, the method further comprises in response to determining that the first device is available, sending the first message to the first wireless device without storing the first message in the first queue. The method further comprises: determining whether a priority of the first message exceeds a priority threshold; and in response to determining that the first message priority exceeds the priority threshold, sending a wakeup message to the first wireless device to cause the first wireless device to wake up. The method also includes in response to the determining that the first message priority does not exceed the priority threshold, not sending the wakeup message to the first wireless device. The method further includes after the first wireless device is active in response to the wakeup message, sending the first message to the first wireless device.

In an implementation, the method further comprises: receiving a status message from the first wireless device, the status message to inform the second wireless device that the first wireless device is active; and in response to the status message, sending at least one message stored in the first queue to the first wireless device. The method also comprises receiving the first message from a third wireless device, the first wireless device and the third wireless device comprising intermittently available devices. The method further includes receiving a registration request message from the first wireless device, the registration request message to request that the second device be registered as the mailbox device to act as an intermediary device to accept one or more messages directed to the first wireless device when the first wireless device is unavailable. The method further comprises sending a broadcast message to one or more other wireless devices in the mesh network, the broadcast message to identify the second wireless device as the mailbox device for the first wireless device.

In another aspect, a non-transitory storage medium comprises instructions that when executed enable a system to perform a method including: initiating, by the system, a mailbox discovery protocol to identify whether at least one wireless device of a mesh network within a communication range of the system is capable of being a mailbox device for the system; in response to identifying the at least one device, selecting a first device to be the mailbox device; performing a registration process to register the first device to be the mailbox device for the system; and causing a broadcast message to be sent within the mesh network to identify the first device as the mailbox device for the system.

In one implementation, the method further comprises selecting the first device to be the mailbox device, wherein the first device is closer to the system than a second device of the mesh network. The method further comprises providing a status message to the first device to indicate that the system is available. The method further comprises after providing the status message to the first device, receiving at least one message from the first device that the first device stored while the system was unavailable. The method further comprises sending a status message to the first device to indicate that the system is entering an inactive state, to cause the first device to store one or more messages for the system during the inactive state of the system.

In yet another aspect, a system includes: at least one transceiver to transmit and receive radio frequency (RF) signals with one or more wireless devices in a mesh network; at least one memory; at least one processor coupled to the at least one memory, the at least one processor to execute instructions; and a non-transitory storage medium coupled to the at least one processor. The non-transitory storage medium includes the instructions which, when executed, cause the at least one processor to: decode at least a portion of a first message received in the system to identify that a first wireless device is a destination of the first message, wherein the system is designated as a mailbox device for the first wireless device; and determine whether the first wireless device is available, and: in response to determining that the first wireless device is available, send the first message directly to the first wireless device; and in response to determining that the first wireless device is not available, store the first message in a mailbox database of the at least one memory.

In one implementation, the non-transitory storage medium further comprises instructions which, when executed, cause the at least one processor to: determine that a priority of the first message exceeds a priority threshold; and in response to determining that the first message priority exceeds the priority threshold, send a wakeup message to the first wireless device to cause the first wireless device to wake up. The non-transitory storage medium further comprises instructions, which when executed, cause the at least one processor, in response to determining that the first message priority does not exceed the priority threshold, not send the wakeup message to the first wireless device. The non-transitory storage medium further comprises instructions which, when executed, cause the at least one processor to: receive a status message from the first wireless device, the status message to inform the system that the first wireless device is active; and in response to the status message, send at least one message stored in the mailbox database to the first wireless device.

In an implementation, the non-transitory storage medium further comprises instructions which, when executed, cause the at least one processor to: receive a registration request message from the first wireless device, the registration request message to request that the system act as the mailbox device for the first wireless device; and in response to the registration request message, register the first wireless device as a mailbox recipient. The non-transitory storage medium further comprises instructions which, when executed, cause the at least one processor to: receive an acknowledgement message from the first wireless device to indicate that the first wireless device received the first message; and send the acknowledgement message to a sender of the first message.

### BRIEF DESCRIPTION OF THE DRAWINGS

FIG. 1 is a block diagram of a wireless network in accordance with an embodiment.

FIG. 2 is a flow diagram of a method in accordance with an embodiment.

FIG. 3 is a flow diagram of a method in accordance with another embodiment.

FIG. 4 is a timing diagram illustrating an asynchronous communication process in accordance with an embodiment.

FIG. 5 is a block diagram of a system in accordance with an embodiment.

FIG. 6 is a block diagram of a representative integrated circuit in accordance with an embodiment.

FIG. 7 is a high level diagram of a network in accordance with an embodiment.

### DETAILED DESCRIPTION

In various embodiments, communication with intermittently powered/connected devices can be intermediated with one or more so-called mailbox devices that are configured to collect and deliver messages on behalf of unavailable devices. Conceptually, the idea is very similar to that of a real world postal service. For example, in a postal service a sender and receiver send and receive messages asynchronously. When the sender intends to send a postal card to the receiver, the receiver is not expected to be available at their postal address to receive the postal card. The postal card stays with the nearest (or designated) postal office of the receiver until delivered to the receiver. Using this analogy, an Internet of Things (IoT) network can be configured such that a sender and a receiver need not be available at the same moment in time to communicate with each other. An intermediary device (analogous to a postal office in a postal service) is configured to take on the role of temporarily staging communication messages to facilitate asynchronous two-way communication between devices when at least one of the devices is only intermittently available.

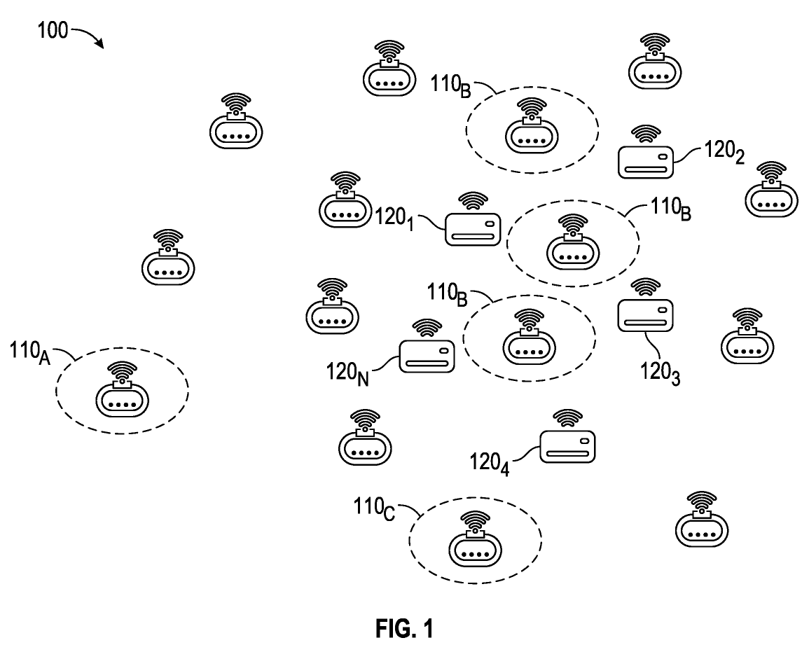

Referring now to FIG. 1, shown is a block diagram of a wireless network in accordance with an embodiment. As shown in FIG. 1, network 100 is implemented as a mesh network. In mesh network 100, many different types of devices may be present. At least some of the devices may be IoT devices, such as a variety of different sensors, monitors, actuators, automation devices, lighting devices, among many other types. As one example, network 100 may be a home automation IoT network, a building automation network, such as for an industrial or commercial location. Still further, network types may include smart networks, e.g., a smart city network, a smart building or home network, a smart lighting network, among others.

In the embodiment of FIG. 1, mesh network 100 is implemented as a typical IoT network that is heterogenous in nature in all aspects, as it is composed of varied kind of devices. This is even true when it comes to the energy budget of individual devices within network 100. Unlike a conventional computer network where each device has a similar set of capabilities, an IoT network such as network 100 can be implemented with a collection of devices having different capabilities, and which communicate with each other using one or more wireless communication channels. Although embodiments are not limited in this regard, as an example mesh network 100 may be a collection of devices including a variety of differently powered devices, including line-powered, non-rechargeable battery-powered, and ambient energy source-powered devices (e.g., solar/wind/radio frequency (RF)/etc.). As examples, these devices can include line-powered meters (e.g., electric meters), wireless routers, LED lamps or so forth, battery-powered smart doorknobs, cameras, smartwatches, home automation devices or so forth, and solar-powered LED lamps, among other such energy harvesting devices.

As illustrated in FIG. 1, different types of IoT devices may be present, including multiple energy harvesting devices 110. Understand that energy harvesting devices may be implemented with battery-less sources of power such as may be realized by leveraging one or more ambient sources of energy. As examples, the ambient sources of energy may include solar, wind, hydroelectric or so forth. In still other cases, an energy harvesting device may receive energy via RF communications.

In any event, understand that depending upon the actual ambient environment and changing nature of the ambient energy sources, one or more energy harvesting devices 110 may be intermittently unavailable. For example, solar-powered devices may not have sufficient stored energy to remain powered overnight. In some cases, energy harvesting devices 110 may be configured to operate according to a predetermined schedule that provides for periodic intervals of availability and nonavailability. In other cases, energy harvesting devices 110 may remain powered and active so long as sufficient power is available. However, when an energy source or stored energy is no longer available, a given energy harvesting device becomes unavailable, for at least a certain time. While implementations are described in the context of energy harvesting devices that may be intermittently unavailable due to lack of power, understand that embodiments also may be used to provide mailbox intermediary capabilities for wireless devices that may become intermittently unavailable, e.g., due to loss of power, connectivity, or for other such reasons.

As further illustrated in FIG. 1, other devices within network 100 are implemented as powered devices. Specifically as shown, a plurality of powered devices 120_{1-N} are present within network 100. In embodiments, powered devices 120 may be maintained in an active state, as they have sufficient energy to be maintained, at least in a low power mode and do not lack for sufficient energy. Depending upon use case, powered devices 120 may include battery-powered devices, line-powered devices or so forth.

In embodiments herein, one or more powered devices 120 can be configured as so-called mailbox devices. These mailbox devices may be configured to act as an intermediary device on behalf of one or more energy harvesting devices 110. In this way, these adequately powered devices can act as an intermediary to accept network communications on behalf of one or more energy harvesting devices 110, at least while such devices are unavailable, e.g., due to a lack of energy source. In various embodiments, powered devices 120 that may be configured as a mailbox device can be an IoT device that is line powered, battery powered with a large energy budget, and/or an energy harvesting device that has a reliable and predictable energy source. As examples, intermediary devices may include line powered devices such as electric meters or street lamps, battery powered devices such as BLE-based water meters or cameras, and energy harvesting devices such as solar powered devices.

As will be described herein, energy harvesting device 110 may be configured with a capability to discover presence of powered devices 120 that are capable of acting as an intermediary device on its behalf and perform a registration process with a given such device to provide for a mailbox capability. In turn, powered devices 120 may be configured with a packet management capability in order to obtain, store and deliver messages on behalf of one or more energy harvesting devices 110, pursuant to a registration process and a subsequent unavailability of a registered device.

As shown in FIG. 1, in a real world mesh network, there can be multiple scenarios as depicted by devices 110_{A}, 110_{B} and 110_{C}. In a given implementation, one or more wireless devices (enumerated as exemplary device 110_{A}) may be too far away from any available mailbox devices, and thus may not be able to register with an intermediary device. One or more other wireless devices (enumerated as devices 110_{B}) may be able to choose from multiple mailbox devices. Such devices may perform a selection process using one or more selection criteria to choose from a list of available mailbox devices. Finally, one or more wireless devices (enumerated as 110_{C}) can have only one mailbox device from which it can have intermediary support.

In embodiments, devices 110 may be configured with a mailbox discovery service, which may be a software-implemented mechanism used to locate and select a mailbox device. In embodiments, devices 120 may be configured with a packet management service, which may be a software-defined mechanism to manage messages from multiple devices. Packet management may include: staging messages temporarily, e.g., via an internal mailbox database to store and manage messages from multiple devices; message delivery to ensure that messages are ultimately routed to the final destination; and security operations. Note that message delivery also may include keeping track of when a device is available or explicitly waking up an energy harvesting device (if possible) to deliver a high priority message. Security may be implemented to ensure data privacy and authenticity, and also to ensure that the mailbox device can be trusted within a network.

With this arrangement and provision of mailbox devices, more complex schemes can be avoided. For example, central management in which a management device instructs an energy harvesting device to enter into an energy conservation mode and wake up after a pre-determined time interval can be avoided. Also, there is no need to cause the energy harvesting devices to be caused to wakeup at preconfigured time intervals, thus avoiding concerns where a device cannot adhere to periodic wakeup events due to unavailability of the energy source(s). Also avoided is the need to predict availability of an energy source, or otherwise support coordinated communication between multiple energy harvesting devices.

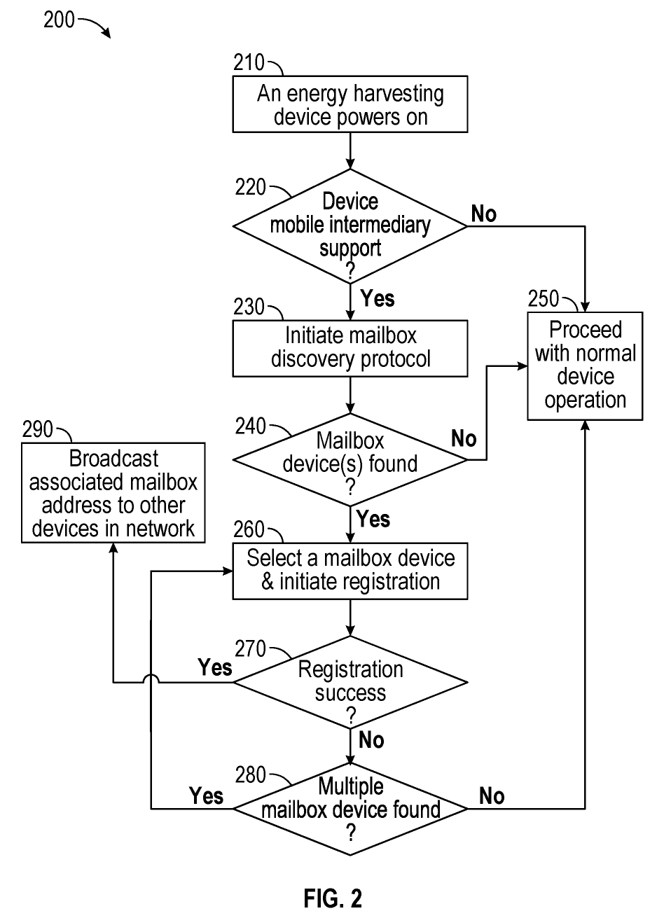

Referring now to FIG. 2, shown is a flow diagram of a method in accordance with an embodiment. More specifically, as shown in FIG. 2, method 200 is a method for performing a mailbox device discovery and pairing process. Method 200 may be performed by an energy harvesting device, e.g., on bootup of the device into a given mesh network. In one or more embodiments, the energy harvesting device may include firmware and/or software to perform method 200. The energy harvesting device may execute instructions of this firmware and/or software via one or more processors of the device.

As shown, method 200 begins by powering on an energy harvesting device (block 210). This power on process may occur once on initialization and bootup of the energy harvesting device within a given mesh network. Or this step may occur each time that the energy harvesting device is powered on, e.g., after gaining access to an energy source, in the case of intermittent powering of the device. Next at diamond 220, it is determined whether the device includes intermediary support. This determination may be based on configuration information included within the energy harvesting device to identify this capability of discovering/pairing with one or more intermediary devices. If no such support is present, control passes to block 250 where the remainder of the bootup process of the energy harvesting device is performed and the device enters normal operation. Note that the support for intermediary support may be implemented by inclusion of firmware, software and/or hardware circuitry to provide a capability of discovery and pairing with an intermediary device. And depending on inclusion of such supported device in a given network, this capability can be enabled, e.g., by a configuration setting.

Still referring to FIG. 2, instead when it is determined that this intermediary support is present, at block 230 a mailbox discovery protocol may be initiated. In one or more embodiments, this mailbox discovery protocol may involve sending out registration request messages to identify presence of available intermediary devices within the mesh network. Based upon the results of this protocol, it is next determined at diamond 240 whether one or more mailbox devices are present and available within the network. If not, control passes to block 250 as discussed above.

When it is determined that one or more such mailbox devices are present, at block 260 a selection process is performed to select a mailbox device and initiate a registration process with that device. Note that in the case of multiple mailbox devices, the selection process may identify a primary candidate for intermediary status. This primary candidate may be based on a determination of the availability and location of the intermediary device. For example, for purposes of reduced latency and power consumption, a nearest available device may be selected. In addition at block 260, a registration process is performed. By way of this registration process, the selected powered device is registered as an intermediary that is capable of accepting messages on behalf of the energy harvesting device, at least for time periods in which the energy harvesting device is not available. In an embodiment, the registration process may include setting up a policy table in the energy harvesting device to identify the mailbox device so that on a wakeup from inactivity, it can request any stored messages from the mailbox device. A similar policy table setting (which may include a list of devices registered to the mailbox device) may be made in the mailbox device to register the energy harvesting device and associate and initialize one or more queues in a mailbox database of the mailbox device with the energy harvesting device.

Still referring to FIG. 2, next at diamond 270, it is determined whether the registration is successful. If not, control passes to diamond 280 to determine whether there is another potential mailbox device available. If not, at block 250 normal operation proceeds. If another device is available, control passes to block 260 where the registration process may be performed with that device.

Finally with reference to FIG. 2, on successful registration of the energy harvesting device with a mailbox device, control passes to block 290. At block 290 a broadcast message is sent to other devices in the network. In one or more embodiments, this broadcast message may include information regarding the registration of the energy harvesting device to the particular powered device. As an example, this broadcast message may include an identification (e.g., address) of the energy harvesting device and its registered intermediate device along with potentially other information. Note that the broadcast message may be sent from the mailbox device (although in some cases it is possible that the energy harvesting device sends the broadcast message). Although shown at this high level in the embodiment of FIG. 2, many variations and alternatives are possible.

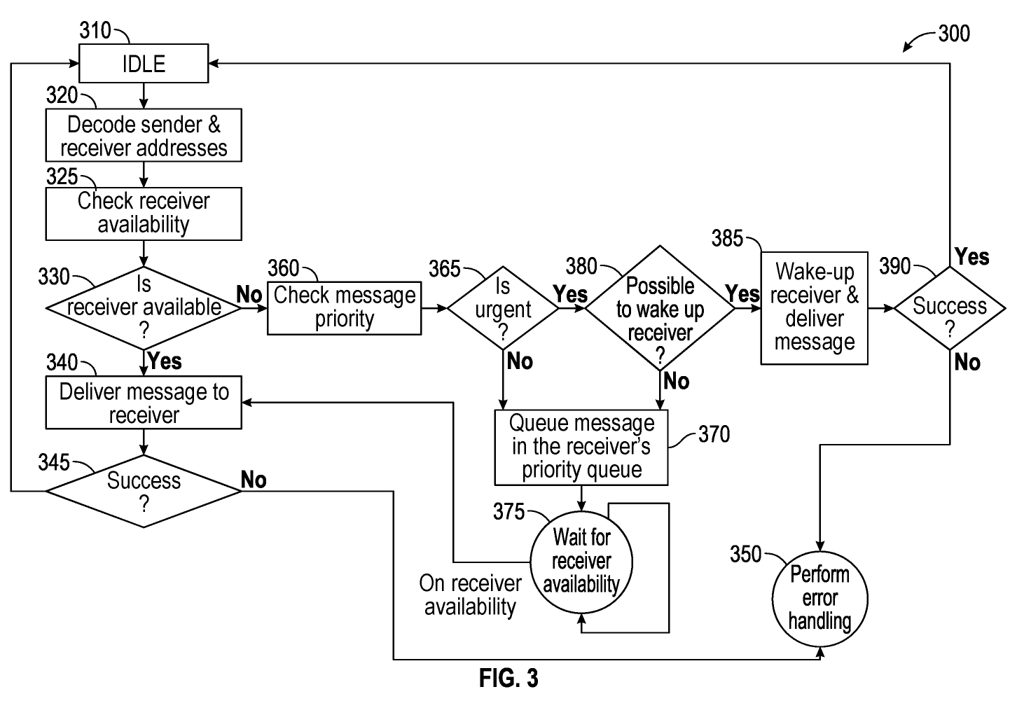

Referring now to FIG. 3, shown is a flow diagram of a method in accordance with another embodiment. In FIG. 3, method 300 is a method for handling incoming messages by a mailbox device on behalf of a given energy harvesting device. The mailbox device may include firmware and/or software to perform method 300. The energy harvesting device may execute instructions of this firmware and/or software via one or more processors of the device.

As shown, method 300 begins in an idle state 310 which is exited on the event of a new incoming message from another device within the network or an indication of a registered energy harvesting device that has become available. Understand that this availability indication triggers transmission of any pending messages stored in the mailbox device.

At block 320, the information of the incoming event is decoded, namely, addresses of the sender and receiver. If the message is directed to a given energy harvesting device that is registered to the mailbox device, at block 325 receiver availability is checked (understand that in FIG. 3, “receiver” is used to refer to a given registered energy harvesting device). In an embodiment, this receiver availability may be determined based on a most recently received status message regarding a current status of the given energy harvesting device. In other cases, the mailbox device may send a ping message to the receiver to determine whether it is available. In another case, the energy harvesting device can set up a number of timeslots with the mailbox device (at the time of registration), which can then act as a trigger for the mailbox device to initiate a communication with the device.

In any case, at diamond 330 it is determined whether the receiver is available. If so, control passes to block 340 where the message is delivered to the receiver. Note that in this instance, the received message can directly be sent from the mailbox device to the registered energy harvesting device without first storing the message into a queue of the mailbox device associated with the energy harvesting device. Next, it is determined whether the message was delivered successfully (diamond 345). In an embodiment, this determination may be based on receipt of an acknowledgement message from the receiver within a predetermined time interval. If unsuccessful, control passes to block 350 where error handling processes may be performed.

Still referring to FIG. 3, if it is determined at diamond 330 that the receiver is not available, control passes to block 360 where a priority of a message may be determined. Understand however that the priority determination, and the alternate message handling based on the priority determination can be optional in some cases. As an example, messages may be marked as being high priority or regular priority. In other cases, more than two levels of priority may be established. In any event, based on the message priority it can be determined at diamond 365 whether the message is urgent, e. g., as determined based on the message priority and a given priority threshold (i.e., if the priority exceeds the priority threshold). If the message is determined to not be urgent, control passes to block 370 where the message is stored in a queue associated with the receiver. Note that this queue may be part of a mailbox database that is stored in a memory of the mailbox device. In various implementations, there may be one or more queues for each energy harvesting device for which the mailbox device acts as an intermediary. For example, there can be separate transmit and receive message queues for each such device. For messages that are stored in such queue, control passes to block 375 to wait for receiver availability. When it is determined that the receiver is available, control passes to block 340 where any messages present in the queue for the receiver can be delivered to the receiver.

With further reference to FIG. 3, if it is determined at diamond 365 that the message is urgent, control passes to diamond 380 to determine whether it is possible to wake up the receiver. To this end, the mailbox device may send a wakeup message that the receiver may successfully respond to, e.g., if available energy is available. If the receiver does not wake up, at block 370, the message is stored in the given queue. Otherwise, when the receiver does wake up responsive to the wakeup message, control passes to block 385 where after the receiver has been activated, the message is delivered to the receiver. At diamond 390, as at block 345, it is determined whether the message was successfully received, with error handling performed at block 350 if not. Although shown at this high level in the embodiment of FIG. 3, understand that many variations and alternatives are possible.

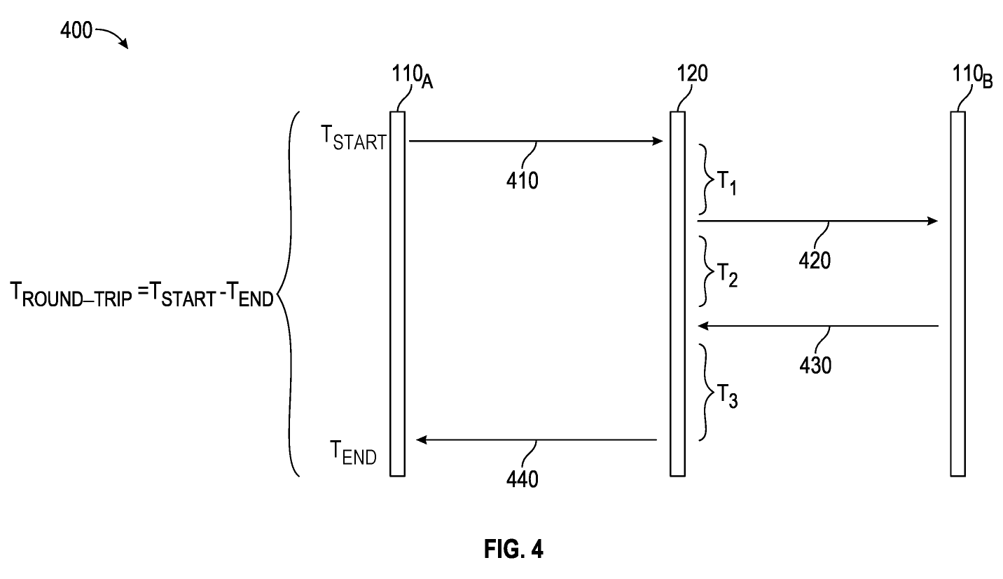

Referring now to FIG. 4, shown is a timing diagram illustrating an asynchronous communication process in accordance with an embodiment. As shown in FIG. 4 communications between a pair of energy harvesting devices (110_{A} and 110_{B}) may be intermediated by a mailbox device (120). Note that TROUND_TRIP is the total time taken for an asynchronous communication event to complete between the two devices using a mailbox device. In addition, T1 is the time period during which the message intended for device 110_{B} is staged by mailbox device 120. During this period, the message is stored in an internal database of mailbox device 120 waiting to be dispatched to target device 110_{B}. T2 is the amount of time taken by energy harvesting device 110_{B} to respond (e.g., via an acknowledgement) to the message delivered by mailbox device 120. This time varies based on the nature of the communication messages and the availability and the energy budget of the individual devices. Finally, T3 is the time period during which the response for device 110_{A} is staged by mailbox device 120. As seen, the message is temporarily stored in the internal database of mailbox device 120 until it can be delivered to device 110_{A}.

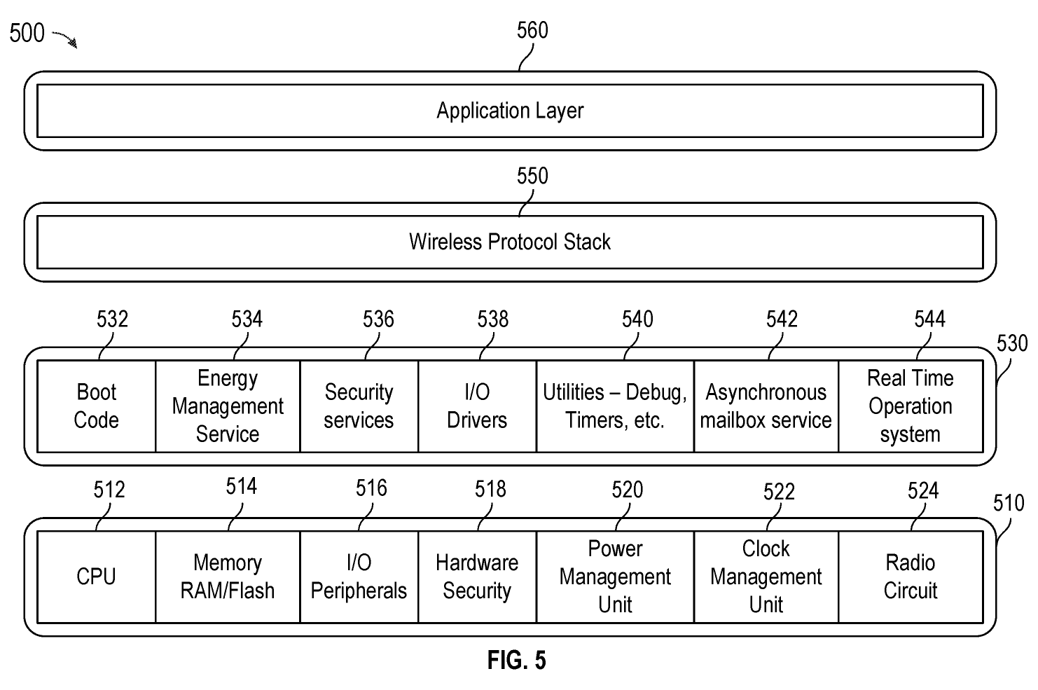

Referring now to FIG. 5, shown is a block diagram of a system in accordance with an embodiment. In FIG. 5, system 500 may be a wireless device to be incorporated into a wireless network and, as shown, is a representation of one or more of a mailbox device or an energy harvesting device. As seen, system 500 includes a SoC 510. Various components are present within SoC 510, including a central processing unit (CPU) 512, memory 514 (which may be implemented as a combination of RAM and flash memory), I/O peripherals 516, security hardware 518, power management unit 520, clock management unit 522, and at least one radio circuit 524. Although shown with these limited components, understand that an SoC may include additional components in other embodiments.

For performing asynchronous mailbox activity as described herein, system 500 may include firmware 530. As shown, firmware 530, which may execute on CPU 512 and memory 514 among other circuitry of SoC 510, includes various components. Specifically, firmware 530 includes boot code 532, an energy management service 534, security services 536, I/O drivers 538, utilities 540, a real time operating system 544, and an asynchronous mailbox service 542. As described herein, asynchronous mailbox service 542 may be configured to perform a discovery protocol (and a resulting registration process) in the case of an energy harvesting device. And in the case of a mailbox device, asynchronous mailbox service 542 may perform the registration process and then act as a mailbox device on behalf of a given one or more energy harvesting devices.

As further illustrated in FIG. 5, system 500 also includes a wireless protocol stack 550 which may include one or more stacks to enable communication according to multiple wireless communication protocols, e.g., including BLE, Wi-Fi, and Thread among others. System 500 also includes an application layer 560 which may include a variety of applications that execute on hardware of SoC 510. Although shown at this high level in the embodiment of FIG. 5, many variations and alternatives are possible.

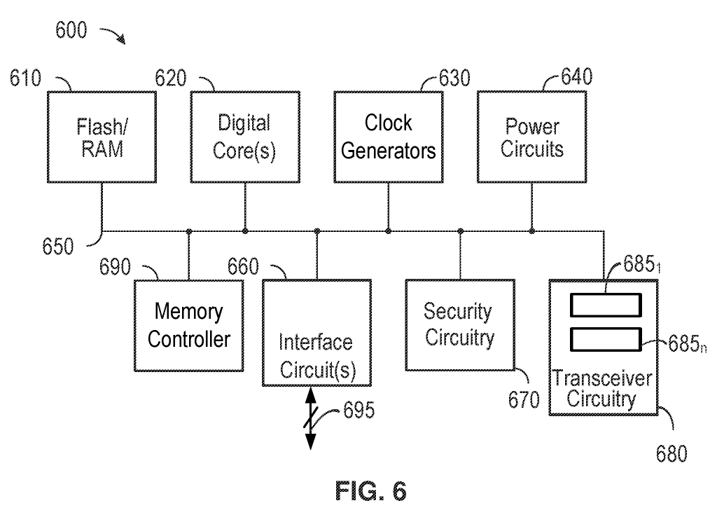

Referring now to FIG. 6, shown is a block diagram of a representative integrated circuit 600 that may be implemented in an energy harvesting device or a mailbox device, as described herein. In the embodiment shown in FIG. 6, integrated circuit 600 may be, e.g., a dual mode wireless transceiver that may operate according to one or more wireless protocols (e.g., WLAN and Bluetooth, among others) or other device that can be used in a variety of use cases. In one or more embodiments, the circuitry of integrated circuit 600 shown in FIG. 6 may be implemented on a single semiconductor die.

Integrated circuit 600 may be included in a range of devices including a variety of stations, including smartphones, wearables, smart home devices, IoT devices, vehicle devices, other consumer devices, or industrial, scientific, and medical (ISM) devices, among others.

In the embodiment shown, integrated circuit 600 includes a memory system 610 which in an embodiment may include volatile storage, such as RAM and non-volatile memory such as a flash memory. The flash memory is a non-transitory storage medium that can store instructions and data. In embodiments, this storage may store firmware to perform mailbox discovery, registration and/or management processes as described herein. As further shown integrated circuit 600 also may include a memory controller 690.

Memory system 610 couples via a bus 650 to one or more digital cores 620, which may include one or more cores and/or microcontrollers that act as processing units of the integrated circuit. In turn, digital cores 620 may couple to clock generators 630 which may provide one or more phase locked loops or other clock generator circuitry to generate various clocks for use by circuitry of the IC.

As further illustrated, IC 600 further includes power circuitry 640, which may perform energy harvesting in the case of an energy harvesting device. Additional circuitry may be present depending on particular implementation to provide various functionality and interaction with external devices. Such circuitry may include interface circuitry 660 which provides a digital communication interface with additional circuitry (such as a memory, to couple to IC 600 via a link 695). IC 600 also may include security circuitry 670 to perform wireless security techniques.

In addition, as shown in FIG. 6, transceiver circuitry 680 may be provided to enable transmission and reception of wireless signals, e.g., according to one or more of a local area or wide area wireless communication scheme, such as Zigbee, Bluetooth, IEEE 802.11, IEEE 802.15.4, cellular communication or so forth. As shown, transceiver circuitry 680 includes multiple transceiver circuits 685₁₋ₙ, to communicate according to multiple wireless communication protocols. Understand while shown with this high level view, many variations and alternatives are possible.

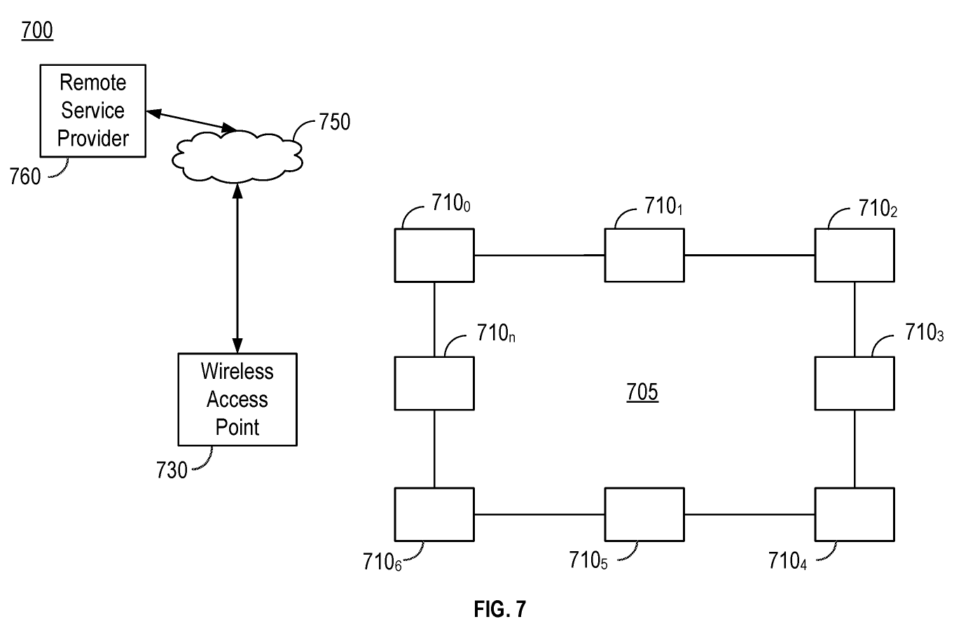

ICs such as described herein may be implemented in a variety of different devices such as wireless stations, IoT devices, vehicle devices or so forth. Referring now to FIG. 7, shown is a high level diagram of a network in accordance with an embodiment. As shown in FIG. 7, a network 700 includes a variety of devices, including wireless stations including smart devices such as IoT devices, access points and remote service providers, which may leverage embodiments for providing intermediary mailbox support for energy harvesting devices as described herein.

In the embodiment of FIG. 7, a wireless network 705 is present, e.g., in a building having multiple wireless devices 710₀₋ₙ. As shown, wireless devices 710, one or more of which may be energy harvesting devices and one or more of which may be configured to be mailbox devices for the energy harvesting devices, couple to an access point 730 that in turn communicates with a remote service provider 760 via a wide area network 750, e.g., the internet. Understand while shown at this high level in the embodiment of FIG. 7, many variations and alternatives are possible.

While the present disclosure has been described with respect to a limited number of implementations, those skilled in the art, having the benefit of this disclosure, will appreciate numerous modifications and variations therefrom. It is intended that the appended claims cover all such modifications and variations.

What is claimed is:

1. A method comprising:
receiving, in a second wireless device of a mesh network, a first message directed to a first wireless device of the mesh network, wherein the second wireless device is designated as a mailbox device for the first wireless device;
determining whether the first wireless device is available; and
in response to determining that the first wireless device is not available, storing the first message in a first queue of the second wireless device, the first queue associated with the first wireless device.

2. The method of claim 1, further comprising in response to determining that the first device is available, sending the first message to the first wireless device without storing the first message in the first queue.

3. The method of claim 1, further comprising:
determining whether a priority of the first message exceeds a priority threshold; and
in response to determining that the first message priority exceeds the priority threshold, sending a wakeup message to the first wireless device to cause the first wireless device to wake up.

4. The method of claim 3, further comprising in response to the determining that the first message priority does not exceed the priority threshold, not sending the wakeup message to the first wireless device.

5. The method of claim 3, further comprising after the first wireless device is active in response to the wakeup message, sending the first message to the first wireless device.

6. The method of claim 1, further comprising:
receiving a status message from the first wireless device, the status message to inform the second wireless device that the first wireless device is active; and
in response to the status message, sending at least one message stored in the first queue to the first wireless device.

7. The method of claim 1, further comprising receiving the first message from a third wireless device, the first wireless device and the third wireless device comprising intermittently available devices.

8. The method of claim 1, further comprising receiving a registration request message from the first wireless device, the registration request message to request that the second device be registered as the mailbox device to act as an intermediary device to accept one or more messages directed to the first wireless device when the first wireless device is unavailable.

9. The method of claim 8, further comprising sending a broadcast message to one or more other wireless devices in the mesh network, the broadcast message to identify the second wireless device as the mailbox device for the first wireless device.

10. A non-transitory storage medium comprising instructions that when executed enable a system to perform a method comprising:
initiating, by the system, a mailbox discovery protocol to identify whether at least one wireless device of a mesh network within a communication range of the system is capable of being a mailbox device for the system;
in response to identifying the at least one device, selecting a first device to be the mailbox device;
performing a registration process to register the first device to be the mailbox device for the system; and
causing a broadcast message to be sent within the mesh network to identify the first device as the mailbox device for the system.

11. The non-transitory storage medium of claim 10, wherein the method further comprises selecting the first device to be the mailbox device, wherein the first device is closer to the system than a second device of the mesh network.

12. The non-transitory storage medium of claim 10, wherein the method further comprises providing a status message to the first device to indicate that the system is available.

13. The non-transitory storage medium of claim 12, wherein the method further comprises after providing the status message to the first device, receiving at least one message from the first device that the first device stored while the system was unavailable.

14. The non-transitory storage medium of claim 10, wherein the method further comprises sending a status message to the first device to indicate that the system is entering an inactive state, to cause the first device to store one or more messages for the system during the inactive state of the system.

15. A system comprising:
at least one transceiver to transmit and receive radio frequency (RF) signals with one or more wireless devices in a mesh network;
at least one memory;
at least one processor coupled to the at least one memory, the at least one processor to execute instructions; and
a non-transitory storage medium coupled to the at least one processor, the non-transitory storage medium comprising the instructions which, when executed, cause the at least one processor to:
decode at least a portion of a first message received in the system to identify that a first wireless device is a destination of the first message, wherein the system is designated as a mailbox device for the first wireless device; and
determine whether the first wireless device is available, and:
in response to determining that the first wireless device is available, send the first message directly to the first wireless device; and
in response to determining that the first wireless device is not available, store the first message in a mailbox database of the at least one memory.

16. The system of claim 15, wherein the non-transitory storage medium further comprises instructions which, when executed, cause the at least one processor to:
determine that a priority of the first message exceeds a priority threshold; and
in response to determining that the first message priority exceeds the priority threshold, send a wakeup message to the first wireless device to cause the first wireless device to wake up.

17. The system of claim 16, wherein the non-transitory storage medium further comprises instructions, which when executed, cause the at least one processor, in response to determining that the first message priority does not exceed the priority threshold, not send the wakeup message to the first wireless device.

18. The system of claim 16, wherein the non-transitory storage medium further comprises instructions which, when executed, cause the at least one processor to:
receive a status message from the first wireless device, the status message to inform the system that the first wireless device is active; and
in response to the status message, send at least one message stored in the mailbox database to the first wireless device.

19. The system of claim 16, wherein the non-transitory storage medium further comprises instructions which, when executed, cause the at least one processor to:
receive a registration request message from the first wireless device, the registration request message to request that the system act as the mailbox device for the first wireless device; and
in response to the registration request message, register the first wireless device as a mailbox recipient.

20. The system of claim 16, wherein the non-transitory storage medium further comprises instructions which, when executed, cause the at least one processor to:
receive an acknowledgement message from the first wireless device to indicate that the first wireless device received the first message; and
send the acknowledgement message to a sender of the first message.
